(19) United States
(12) Patent Application Publication
(10) Pub. No.: US 2026/0192873 A1
(43) Pub. Date: Jul. 9, 2026

(54) Work Machine System with a Tractor Unit and Interchangeable Trailer Units

(71) Applicant: Caterpillar SARL, Geneva (CH)

(72) Inventor: Stephen HERD, Durham (GB)

(73) Assignee: Caterpillar SARL, Geneva (CH)

(21) Appl. No.: 18/868,387

(22) PCT Filed: May 24, 2023
(86) PCT No.: PCT/EP2023/025241

§ 371 Date: Nov. 22, 2024

(30) Foreign Application Priority Data
May 27, 2022 (GB) 2207884.4

(51) Int. Cl. B62D 53/00; B60K 1/04; B62D 59/04; B62D 63/06

(52) U.S. Cl. CPC B62D 53/005; B62D 59/04; B62D 63/06; B60K 2001/0444

(57) ABSTRACT

Interchangeable trailer units for a work machine system and a work machine comprising a tractor unit releasably connectable to interchangeable trailer units by a coupling. Tractor and trailer unit ground engagers, are driven by electrical power systems and the electrical power is distributed across the entire work machine power system. The trailer units can be swapped once their power sources run low.

### TECHNICAL FIELD

This disclosure is directed towards an interchangeable trailer unit for releasably coupling to a tractor unit to form a work machine, a work machine system with tractor unit and interchangeable trailer units and a method of operating such a work machine. This disclosure is particularly directed towards electrical power distribution across such a work machine system.

### BACKGROUND

Machines, such as articulated machines and/or off-highway vehicles including articulated trucks, scrapers (such as wheel tractor scrapers) and mining trucks (particularly underground mining trucks), commonly comprise a tractor unit connected to a trailer unit. These machines comprise one or more articulated joints allowing for articulation between the tractor and trailer units (e.g. for steering) and/or oscillation between the tractor and trailer units (e.g. as the tractor and trailer units independently roll at different angles as they move over a rough terrain). Commonly, the tractor comprises either a single axle or only two ground engaging components, wheels or the like, and as such, is stabilized by the articulated connection with the trailer.

The tractor and trailer units are permanently coupled to each another about the joint and are fully integrated with one another so that the machine is purposively designed to perform a certain range of tasks. As a result, for example, the units of an articulated truck may be designed to receive material from an excavator and transport such material in an open worksite, the units of a mining truck may be designed to transport material in an underground mine and the units of a wheel tractor scraper may be designed to collect material itself and transport the material around a worksite. Yet furthermore, the tractor and trailer units of articulated trucks may be designed for specific uses, such as by having a dump body or ejector body, for carrying containers, water, cable reels or fuel, for operating as a hooklift or by having high-capacity bodies for coal or waste and so on.

Worksites therefore often require several different work machines to suit different applications. Whilst such an approach ensures that an appropriate and efficient machine for a certain task is selected, it can mean that some types of machines remain idle on a worksite when they are not required, meaning they have a low rate of utilisation. In addition, it is often complex, time intensive and costly to design and manufacture a dedicated machine, including both its tractor and trailer unit, to fulfil a specific user requirement.

Furthermore, articulated hauling earthmoving machines driven by electrical battery systems may not be able to store sufficient energy on board to be able to complete a full working shift without the need for recharging. However, recharging takes a significant amount of time during which the machine is unproductive. An alternative approach is to swap batteries, but this requires batteries to be easily detachable and therefore limits the potential locations of the battery on the machine.

### SUMMARY

The present disclosure provides an interchangeable trailer unit, work machine system and method in accordance with the claims. The present disclosure is generally directed towards interchangeable trailer units for a work machine system and a work machine comprising a tractor unit releasably connectable to interchangeable trailer units by a coupling. The tractor and trailer unit ground engagers are driven by electrical power systems and the electrical power is distributed across the entire work machine power system via tractor and trailer power distribution systems. The trailer units can be swapped once their power sources run low, resulting in the work machine being operable again in less time than if the power sources were recharged whilst the tractor unit was coupled. Furthermore, the work machine system of the present disclosure is more convenient than swapping power sources since the power sources required are so large and the positioning of the power sources within the machine may provide poor access thereto.

The work machine system of the present disclosure takes advantage of the similarities between certain types of work machines by having a unified tractor unit whilst enabling a plurality of different work functions to be performed with just one tractor unit by the trailer units being releasably couplable to the tractor unit. When a work machine has almost depleted its power sources, it could then be uncoupled from the trailer unit and attached to a fully charged trailer unit. The depleted trailer power source in the original trailer unit may be returned to charge. The work machine is therefore only out of use for the time it takes to decouple the trailer unit and recouple a fully charged trailer unit to the tractor unit. By employing this method, the trailer power source can be fully integrated into the chassis of the trailer unit (as opposed to battery swap alternatives). By configuring the work machines in such a way that a significant portion of the power source capacity is on the trailer unit, the trailer unit swap can effectively act as a power source swap. The full power distribution across the work machine electrical power system improves the flexibility of power source charging and discharging.

The forward direction of the machine, in which it operates the majority of the time, is with the trailer unit behind the tractor unit.

The interchangeable trailer unit is for releasably coupling to a tractor unit to form a work machine. The tractor unit comprises a tractor power system having a tractor power distribution system connected to at least one tractor motor for driving tractor ground engagers about a tractor rotational axis. In embodiments, the tractor unit comprises no further driven tractor ground engagers and when driven is balanced by the trailer unit and/or the tractor ground engagers comprise only a pair of wheels rotating around a tractor rotational axis. The trailer unit comprises at least one trailer ground engager and a trailer power system comprising a trailer power distribution system connected to a trailer power source. A trailer services connection is for releasably connecting to a tractor services connection of the tractor unit and is for connecting the trailer power distribution system to the tractor power distribution system such that electrical power can be distributed therebetween such that electrical power from the trailer power source is suppliable to the at least one tractor motor.

The work machine system comprises a tractor unit comprising a tractor power system having a tractor power distribution system connected to at least one tractor motor for driving tractor ground engagers about a tractor rotational axis. A plurality of trailer units are also provided, each trailer unit comprising at least one trailer ground engager and a trailer power system having a trailer power distribution system connected to a trailer power source. The tractor unit comprises a tractor services connection and each trailer unit comprises a trailer services connection. The tractor and trailer services connections are for releasably electrically connecting the tractor power distribution system to the trailer power distribution system of each trailer unit such that electrical power can be distributed to the tractor motor from the trailer power source.

The method comprises operating a first work machine comprising the tractor unit coupled to a first trailer unit. The at least one tractor motor drives the at least one tractor ground engager by receiving electrical power from the trailer power source via the trailer power distribution system of the first trailer unit and the tractor power distribution system. The tractor unit is uncoupled from the first trailer unit. The tractor unit is coupled to a second trailer unit, thereby forming a second work machine. The second work machine is operated and the at least one tractor motor drives the at least one tractor ground engager by receiving electrical power from the trailer power source via the trailer power distribution system of the second trailer unit and the tractor power distribution system.

In embodiments the trailer power system comprises at least one trailer motor for driving the at least one trailer ground engager and the trailer power source is for supplying power to the at least one trailer motor via the trailer power distribution system. The trailer services connection is for releasably electrically connecting the trailer unit to the tractor unit such that electrical power can be distributed to the tractor and trailer motors from the trailer power source, and a tractor power source if present, via the tractor and trailer power distribution systems.

The present disclosure also provides a work machine comprising: a trailer unit comprising a trailer motor for driving at least one trailer ground engager and a trailer power source for supplying power to the trailer motor; a tractor unit comprising a tractor motor for driving at least one tractor ground engager and a tractor power source for supplying power to the tractor motor, the at least one tractor ground engager being arranged such that the tractor unit is not independently moveable about a terrain without external support including by the trailer unit; and a connector for releasably electrically connecting the tractor unit to the trailer unit such that power can be distributed to the tractor and trailer motors from either of the tractor and trailer power sources.

### BRIEF DESCRIPTION OF THE DRAWINGS

By way of example only, embodiments of the present disclosure are now described with reference to, and as shown in, the accompanying drawings, in which:

FIG. 1 is a schematic perspective view of a work machine system in accordance with the present disclosure including a tractor unit and a plurality of interchangeable trailer units;

FIG. 2 is a side elevation of a work machine form from a tractor unit and one of the trailer units of the work machine system of FIG. 1;

FIG. 3 is a magnified view of a portion of FIG. 2 illustrating a tractor-trailer coupling of the work machine;

FIG. 4 is a schematic of a work machine control system for the work machine of the present disclosure;

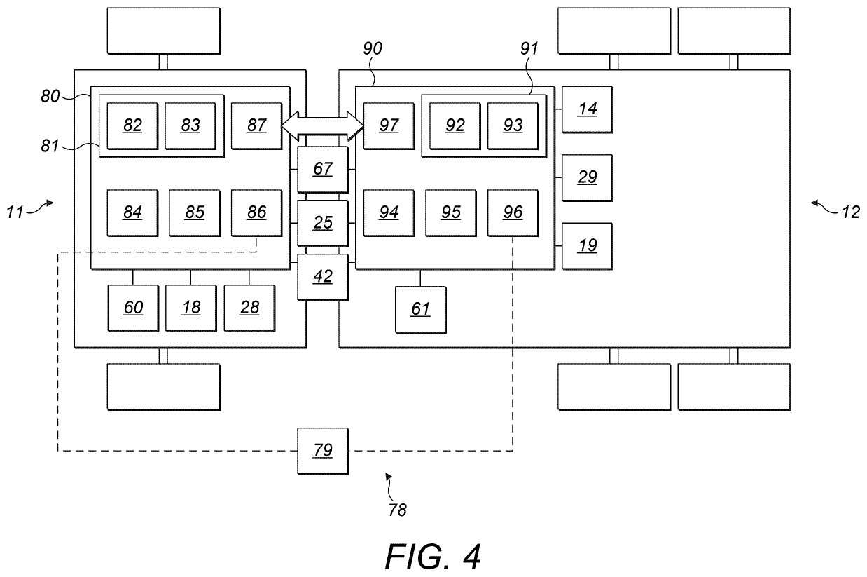

FIG. 5 is a schematic of a work machine power system for the work machine of the present disclosure; and

FIG. 6 is a schematic perspective view of a trailer unit of the present disclosure.

### DETAILED DESCRIPTION

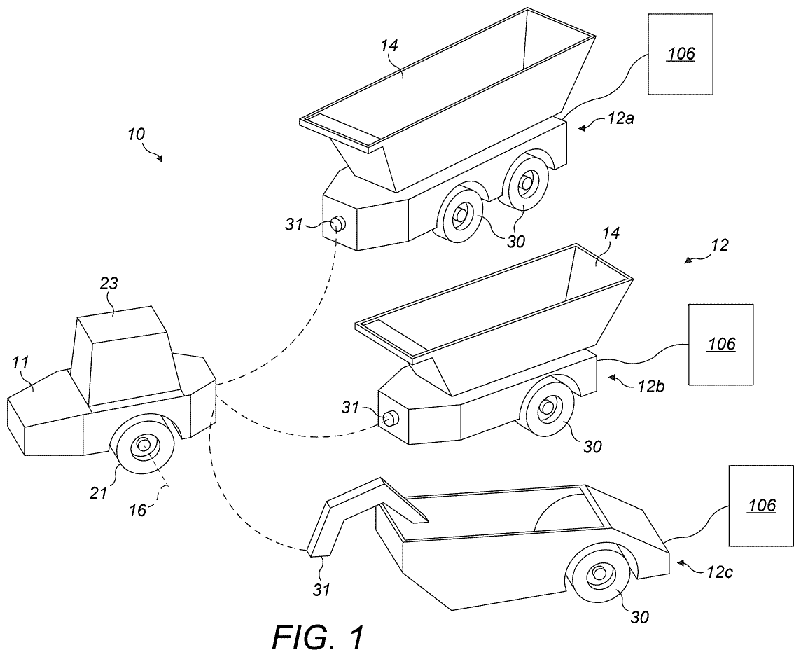

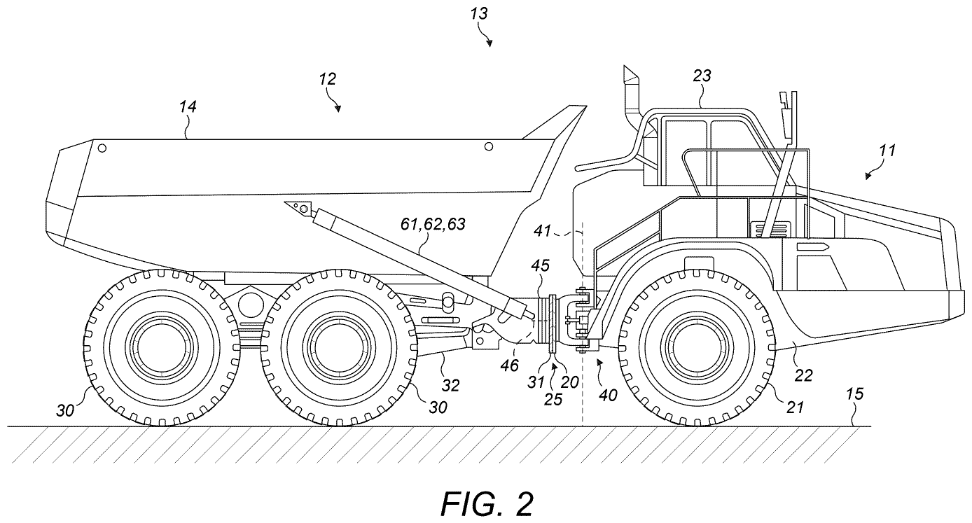

FIG. 1 schematically illustrates a work machine system 10 comprising a tractor unit 11 and a plurality of interchangeable trailer units 12 in accordance with the present disclosure. The tractor unit 11 is coupleable to each of the trailer units 12 and a work machine 13, an example of which is illustrated in FIG. 2, is formed by the tractor unit 11 being coupled to one of the trailer units 12. The work machine 13 formed from the tractor unit 11 and one of the trailer units 12 may be configured for off-highway operation and/or the tractor and trailer units 11, 12 comprise off-highway wheels or tracks mounted to an off-highway suspension system. The work machine 13 may be an earth moving machine.

In general, each of the tractor and trailer units 11, 12 are not designed as standalone vehicles and serve no practical purpose in isolation. However, once coupled together, the tractor and trailer units 11, 12 together form a fully integrated work machine 13.

The tractor unit 11 comprises a tractor coupling 20 and at least one tractor ground engager 21 driven by a tractor power system 18. The tractor unit 11 may alternatively be referred to as a drive unit and generally refers to the unit that provides the main driving power to the work machine 13. The tractor power system 18 is discussed in further detail below.

The at least one tractor ground engager 21 may be wheels as illustrated or may comprise tracks, a roller or the like. The at least one tractor ground engager 21 may rotate about a tractor rotational axis 16 and may comprise a pair of wheels driven about the tractor rotational axis 16. The pair of wheels may be mounted to a single axle or may have motors mounted directly thereto.

The tractor unit 11 may comprise a tractor frame 22 (which may be the chassis and/or main body of the tractor unit 11) and may comprise a cab 23 for an operator. The cab 23 may be mounted to the tractor frame 22 and may comprise the operator controls for controlling the work machine 13. The tractor unit 11 may comprise a tractor braking system 28 for braking the tractor unit 11, such as by applying a braking force to the at least one tractor ground engager 21. The at least one tractor ground engager 21 (for example via a suspension system), cab 23, tractor power system 18, tractor braking system 28, tractor electrical power system 38 and/or tractor coupling 20 may be mounted to the tractor frame 22.

The tractor unit 11 may not be independently moveable about the ground 15 by the tractor power system 18 when the tractor unit 11 is not coupled to a trailer unit 12. The tractor unit 11 comprises no further tractor ground engagers and when driven is balanced by the trailer unit 12. The tractor unit 11 comprises no further tractor ground engagers in contact with the ground 15 when the work machine 13 is driven across the ground 15, for example comprising only a pair of wheels rotating around the tractor rotational axis 16. The centre of mass of the tractor unit 11 may also be offset from the at least one tractor ground engager 21 and/or tractor rotational axis 16 such that the tractor unit 11 is unbalanced when not coupled to a trailer unit 12. The coupling between the tractor and trailer units 11, 12 may counterbalance rotation of the tractor unit 11 about the tractor rotational axis 16 due to the offset centre of mass.

The tractor unit 11 may comprise a tractor control system 80 for controlling the functions thereof. The tractor control system 80 may be connected to and control the tractor power system 18, tractor electrical power system 38 and/or braking system 28.

Each trailer unit 12 comprises at least one trailer ground engager 30 and a trailer coupling 31, which may be mounted to a trailer frame 32 of the trailer unit 12 (which may be the chassis and/or main body of the trailer unit 12). The tractor and trailer couplings 20, 31 are couplable together and form a tractor-trailer coupling 25. Each trailer unit 12 may comprise a haul body or tool 14 for performing work functions. The trailer unit 12 may comprise a trailer braking system 29 for braking the trailer unit 12, such as by applying a braking force to the at least one trailer ground engager 30.

The trailer units 12 may each be different and may be configured for performing different work functions. For example, each trailer unit 12 may comprise a different at least one haul body or tool 14 comprising a dump body, scraper, ejector body, open container, container for water, fuel, lubricant or the like, cable reel, hooklift, high-capacity body for coal or waste, low profile body for underground mining, flat bed, cement mixer, forestry body, shipping container bed, pipe carrier and so on. For example, FIG. 1 illustrates a trailer unit 12a comprising a dump body 14, a trailer unit 12b comprising a low-profile body for underground mining and a trailer unit 12c for forming a wheel tractor scraper.

As a result, when each trailer unit 12 is coupled to the tractor unit 11 a different work machine 13 with different work functions is formed, such as an articulated truck, a mining truck (such as an underground mining truck) or a scraper (such as a wheel tractor scraper). For example, FIG. 2 illustrates a work machine 13 in the form of an articulated hauler formed by a trailer unit 12 with a dump body 14 being coupled to the tractor unit 11. Thus, the same tractor unit 11 can be used to form different work machines 13 and/or perform different work functions by coupling different trailer units 12 thereto.

The at least one trailer ground engager 30 may comprise at least one pair of wheels as illustrated or may comprise tracks, a roller or the like depending upon the work function of the trailer unit 12. The at least one trailer ground engager 30 may be mounted to the trailer frame 32 by a trailer suspension system.

Each trailer unit 12 comprises a trailer power system 19 which may be connected to and for driving the at least one trailer ground engager 30. The trailer power system 19 is described in further detail below.

The trailer units 12 with the trailer power system 19 may not be independently moveable about the ground 15 by the trailer power system 19 when the tractor unit 11 is not coupled to the at least one trailer unit 12. For example, the trailer units 12 may comprise no steering system.

The trailer unit 12 may comprise a trailer control system 90 for controlling the functions thereof. The trailer control system 90 may be connected to and control the trailer power system 19 and/or trailer braking system 29.

The work machine 13 is generally configured to operate in a forward direction for a majority of its operation with the trailer unit 12 behind the tractor unit 11. Therefore, the tractor unit 11 may be configured to pull the trailer unit 12 for a majority of its operating time. Whilst the work machine 13 may be able to reverse, travelling with the tractor unit 11 behind the trailer unit 12, the components thereof are designed and configured to operate at a maximum forward speed in the forward direction with the tractor unit 11 pulling the trailer unit 12. The maximum rated forward speed, with the trailer unit 12 behind the tractor unit 11, may be greater than the maximum rated reversing speed, with the tractor unit 11 behind the trailer unit 12.

The tractor and trailer units 11, 12 are pivotable at least partially relative to one another about an articulation joint 40, which may be along an articulation axis 41. The articulation joint 40 may allow pivoting of at least part of the tractor unit 11 relative to at least part of the trailer units 12 relative to one another in a horizontal plane substantially parallel to the ground 15. The articulation joint 40 may be of any suitable configuration, such as including a pin as illustrated.

Steering of the work machine 13 is achieved by a steering system 42 which controls pivoting about the articulation joint 40. The steering system 42 may be of any suitable configuration. As illustrated the steering system 42 may comprise at least one actuator 43, for example at least one hydraulic cylinder, extending across the articulation joint 40 and for controlling the pivoting about the articulation joint 40. The articulation joint 40 and/or steering system 42 may be mounted to the tractor and/or trailer frames 22, 32. The steering system 42 may be controlled by the tractor and/or trailer control system 80, 90.

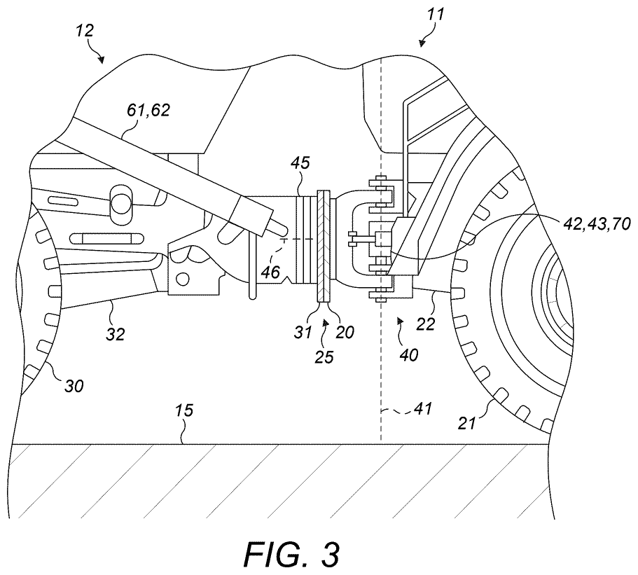

As illustrated in FIGS. 2 and 3, the tractor unit 11 may comprise the articulation joint 40 and steering system 42. The articulation joint 40 and steering system 42 may be located between the tractor coupling 20 and the tractor frame 22. Hence the tractor coupling 20 may be mounted on the other side of the articulation joint 40 to the tractor frame 22. The tractor coupling 20 may be pivotable about the articulation axis 41 relative to the tractor frame 22. As a result, in such an arrangement it is not necessary to have multiple articulation joints 40 or steering systems 42 on each trailer unit 12, thereby reducing redundancy.

Alternatively, and not shown in the Figures, the trailer unit 12 may comprise the articulation joint 40 and steering system 42. The articulation joint 40 and steering system 42 may be located between the trailer coupling 31 and the trailer frame 32. Hence the trailer coupling 31 may be mounted on the other side of the articulation joint 40 to the trailer frame 32. The trailer coupling 31 may be pivotable about the articulation axis 41 relative to the trailer frame 32. As a result of this arrangement the articulation joint 40 and steering system 42 can be designed to suit the specific work function of each trailer unit 12.

In a further embodiment both the tractor and trailer units 11, 12 may comprise separate articulation joints 40 and steering systems 42 on either side of the tractor-trailer coupling 25. Therefore, the versatility of the articulation and steering of the work machine 13 may be improved.

The tractor and/or trailer units 11, 12 may comprise an oscillation hitch 45 for enabling oscillation of the tractor and trailer units 11, 12 relative to one another when the tractor and trailer couplings 20, 31 are coupled. The oscillation hitch 45 may enable oscillation about an oscillation axis 46 such that the tractor and trailer units 11, 12 can roll relative to one another. The oscillation axis 46 may be orthogonal to the articulation axis 41 and the articulation and oscillation axes 41, 46 may extend in the same plane, which may be orthogonal to a plane parallel to the ground 15.

The trailer unit 12 may comprise the oscillation hitch 45 and the oscillation hitch 45 may be mounted between the trailer coupling 31 and trailer frame 32 such that the trailer coupling 31 can oscillate relative to the trailer frame 32. Alternatively, the tractor unit 11 may comprise the oscillation hitch 45 and the oscillation hitch 45 may be mounted between the tractor coupling 20 and tractor frame 22 such that the tractor coupling 20 can oscillate relative to the tractor frame 22.

The oscillation hitch 45 may be on the opposing side of the tractor-trailer coupling 25 to the articulation joint 40. Alternatively, the oscillation hitch 45 may be on tractor or trailer unit 11, 12 with the articulation joint 40, for example by being located between the articulation joint 40 and the tractor or trailer coupling 20, 31 respectively.

Rather than having an oscillation hitch 45, oscillation may be achieved through the suspension system of the tractor and/or trailer unit 11, 12.

The tractor and trailer couplings 20, 31 together form the tractor-trailer coupling 25 of the work machine 13 for mechanically connecting the tractor and trailer units 11, 12 together. The tractor-trailer coupling 25 may be the only part carrying the mechanical load between the tractor and trailer units 11, 12. The tractor-trailer coupling 25 may be configured to be coupled and uncoupled to change the trailer unit 12 attached to the tractor unit 11 by an operator on a worksite without external assistance. The tractor-trailer coupling 25 may or may not require any tools to couple and uncouple and is not permanent. Hence the tractor unit 11 and tractor coupling 20 are configured to be coupled and uncoupled from a plurality of trailer units 12 throughout their rated lifetime. The tractor-trailer coupling 25 may be a bolted flange requiring tools for coupling and uncoupling.

The tractor-trailer coupling 25 may be a quick disconnect coupler and may have any suitable arrangement allowing for the quick changing of a trailer unit 12.

The tractor unit 11 may comprise a tractor fluid system 60 for controlling hydraulic and/or pneumatic functions of the tractor unit 11, such as the steering system 42. The trailer unit 12 may comprise a trailer fluid system 61 for controlling hydraulic and/or pneumatic functions of the trailer unit 12, such as the steering system 42 and/or a cylinder 62 for raising and lowering a dump body 14. The tractor and/or trailer fluid system 60 may each comprise at least one pump for selectively directing fluid between a reservoir and at least one actuator 43, 62. The tractor and trailer fluid system 60, 61 may be controlled by the tractor and trailer control systems 80, 90 respectively.

The tractor unit 11 may comprise a tractor services connection 65 and each trailer unit 12 may comprise a trailer services connection 66 and the tractor services connection 65 may be coupleable to each trailer services connection 66 for the transfer of electrical power (e.g. high voltage power), fluid and/or control signals (e.g. low voltage control signals) between the tractor and trailer units 11, 12. The tractor and trailer services connection 65, 66 may together form a tractor-trailer services connection 67. The tractor and trailer services connections 65, 66 may be mounted to the tractor and trailer frames 22, 32.

The tractor-trailer services connection 67 may enable the transfer of electrical power between the tractor and trailer power systems 18, 19, the transfer of fluid (pneumatic and/or hydraulic) between the tractor and trailer fluid systems 60, 61 and/or the transfer of control signals between the tractor and trailer control systems 80, 90. Thus, when the tractor-trailer services connection 67 between the tractor unit 11 and one of the trailer units 12 is coupled, tractor and trailer power systems 18, 19 may form an integrated work machine electrical power system 17, the tractor and trailer fluid systems 60, 61 may form an integrated work machine fluid system 63 and/or the tractor and trailer control systems 80, 90 may form an integrated work machine control system 78. Thus, the tractor unit 11 may be able to control the trailer unit 12 and vice-versa.

The tractor and trailer couplings 20, 31 may mechanically connect the tractor and trailer units 11, 12 for allowing the transfer of load between them. The coupling of the tractor and trailer couplings 20, 31 may bring the tractor and trailer services connections 65, 66 into alignment with one another for connection together. Thus, the work machine electrical power, fluid and control systems 63, 78 may be formed.

In the work machine fluid system 63, pressurised fluid may be shared between the tractor and trailer fluid systems 60, 61 such that fluid actuators in either of the tractor and trailer units 11, 12 may be controlled by pumps in either of the tractor and trailer units 11, 12. In particular, the work machine fluid system 63 may enable the control of fluid actuators in the trailer unit 12 by at least one pump in the tractor unit 11.

The work machine control system 78 is illustrated further in FIG. 3. The tractor and/or trailer control systems 80, 90 may each comprise a tractor and/or trailer controller 81, 91, for controlling the various parts of the tractor and trailer units 11, 12 respectively. The tractor and/or trailer controller 81, 91 may be of any suitable known type and may comprise an engine control unit (ECU) or the like. The tractor and/or trailer controller 81, 91 may comprise multiple control units, such as an ECU, auxiliary ECU(s) or control unit(s), artificial intelligence control unit(s) and the like. Generally, the tractor and/or trailer controller 81, 91 may comprise a tractor and/or trailer memory 82, 92 (e.g. multiple memories on different control units), which may store instructions or algorithms in the form of data, and a tractor and/or trailer processing unit 83, 93 (e.g. multiple processing units on different control units), which may be configured to perform operations based upon the instructions. The tractor and/or trailer memory 82, 92 may comprise one or more suitable computer-accessible or non-transitory storage mediums for storing computer program instructions, such as RAM, SDRAM, DDR SDRAM, RDRAM, SRAM, ROM, magnetic media, optical media and the like. The tractor and/or trailer processing unit 83, 93 may comprise one or more suitable processors capable of executing memory-stored instructions, such as a microprocessor, uniprocessor, a multiprocessor and the like. The tractor and/or trailer controller 81, 91 may further comprise one or more graphics processing units (e.g. multiple graphics processing units on different control units) for rendering objects for viewing on a tractor and/or trailer display 84, 94, which may only be present on the tractor unit 11 such as in the cab 23, and any other computing system equipment required for performing the functions of the tractor unit 11 and trailer unit 12.

The tractor controller 81 may be communicatively connected (via a wired or wireless connection), to receive inputs from and/or exchange data with, at least one tractor operator input 85, which may be in the cab 23. The trailer controller 91 may be communicatively connected (via a wired or wireless connection), to receive inputs from and/or exchange data with, at least one trailer operator input 95, which may be on a control panel of the trailer unit 12.

The tractor and/or trailer control systems 80, 90 may each comprise a tractor and/or trailer external communication system 86, 96 for transferring data between the control system(s) 80, 90 and a remote computer system 79. The tractor and/or trailer external communication system(s) 86, 96 may comprise any type of suitable apparatus for communication therebetween, particularly a wireless network. Exemplary wireless networks include a satellite communication network, broadband communication network, cellular, Bluetooth, microwave, point-to-point wireless, point-to-multipoint wireless, multipoint-to-multipoint wireless, Wireless Local Service (Wi-Fi Dongle), Dedicated Short-Range Communications (DSRC) or any other wireless communication network. The remote computer system 79 may be under the control of the owner or manufacturer of the work machine system 10.

The tractor and/or trailer control systems 80, 90 may each comprise a tractor and/or trailer control communication module 87, 97 for transferring control signals between the tractor and/or trailer control system(s) 80, 90. The tractor and/or trailer control communication modules 87, 97 may be the same as the tractor and/or trailer external communication system 86, 96 and may be configured for wirelessly transferring control signals between the tractor and/or trailer control systems 80, 90. Alternatively, the tractor and/or trailer control communication modules 87, 97 may comprise connectable interfaces for a wired connection between the tractor and/or trailer control systems 80, 90 and may be configured to be connected during the connection of the tractor-trailer services connection 67. In particular, the tractor and/or trailer control communication modules 87, 97 may be or comprise the control ports 70, 73 of the tractor and trailer services connections 65, 66 respectively.

The tractor control system 80 and/or tractor controller 81 may be connected to and operable to control (a) the tractor power system 18 and/or tractor braking system 28 to control the speed of the work machine 13, (b) the tractor fluid system 60, (c) the steering system 42 to control the steering and direction of travel of the work machine 13, (d) the tractor-trailer coupling 25 to control coupling of the tractor and trailer units 11, 12 and/or (e) tractor-trailer services connection 67 to control the coupling of the tractor and trailer power systems 18, 19, tractor and trailer control systems 80, 90 and/or tractor and trailer fluid systems 60, 61.

The tractor control system 80 may be directly connected to (i.e., rather than via the tractor control communication module 87 and/or external communication system 86) and operable to control (c) to (e) if the actuators of the steering system 42, tractor-trailer coupling 25 and/or tractor-trailer services connection 67 are mounted to the tractor unit 11.

The trailer control system 90 and/or controller 91 may be connected to and operable to control (f) the trailer braking system 29 and the trailer power system 19 to control the speed of the work machine 13, (g) the trailer fluid system 61, and/or (h) the haul body or tool 14 for performing work functions. The trailer control system 90 may be directly connected to (i.e., rather than via the trailer control communication module 97 and/or external communication system 96) and operable to control (c) to (e) if the actuators of the steering system 42, tractor-trailer coupling 25 and/or tractor-trailer services connection 67 are mounted to the trailer unit 12.

The tractor and/or trailer control systems 80, 90 may be configured to control (a) to (h) based upon inputs from the operator to the tractor and/or trailer operator input 85, 95 and/or via a control strategy, which may be implemented by the tractor and/or trailer processing units 83, 93 implementing instructions stored on the tractor and/or trailer memories 82, 92 and/or received from the remote computer system 79.

By virtue of the connection between the tractor and trailer control systems 80, 90, such as via the tractor and/or trailer control communication modules 87, 97, control signals may also be exchanged between the tractor and trailer units 11, 12. Therefore, when the tractor and trailer units 11, 12 are coupled together, the tractor control system 80 may be configured to control (f) to (h) and/or the trailer control system 90 may be configured to control (a) to (c). Therefore, the tractor unit 11 may be operable to control (f) to (h) on a plurality of trailer units 12 when the tractor unit 11 is coupled to each of the trailer units 12.

The tractor control system 80 may be configured to control the tractor and trailer power systems 18, 19 and the tractor and trailer braking systems 28, 29 (the latter optionally via the trailer control system 90) simultaneously to control the drive, braking and/or traction across the work machine 13.

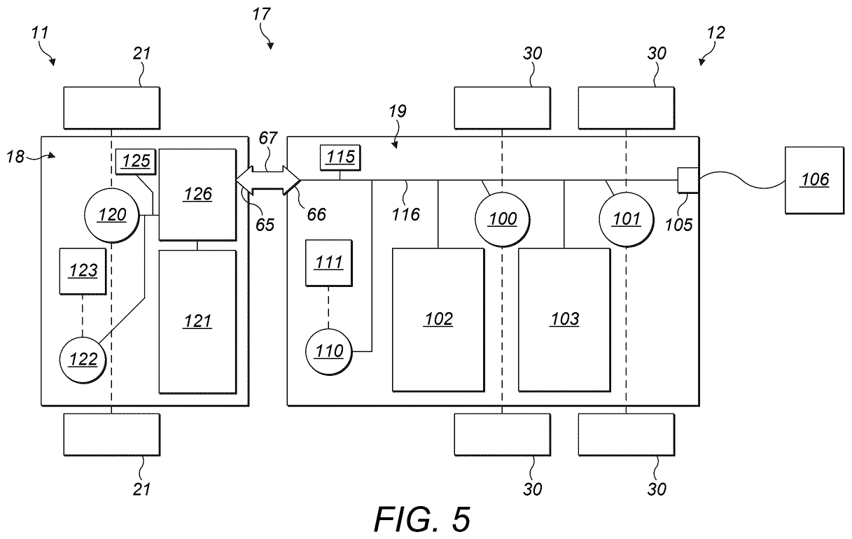

The work machine electrical power system 17 is illustrated further in FIG. 5, including the tractor and trailer power systems 18, 19. The trailer power system 19 may comprise at least one trailer motor 100, 101 for driving the at least one trailer ground engager 30 and comprises a trailer power source 102, 103 for supplying power to the at least one trailer motor 100, 101. The trailer power system 19 comprises a trailer power distribution system 116, for example comprising cables and/or buses, for connected to the trailer power source 102, 103 and may be connected to the at least one trailer motor 100, 101. The trailer power distribution system 116 may be for distributing power supplied from the trailer power source 102, 103 throughout the trailer power system 19, such as to the at least one trailer motor 100, 101.

As illustrated in FIG. 5, the or each trailer motor 100, 101 may be mounted to a pair of trailer ground engagers 30, in this case wheels, such as by an axle. An axle powertrain may extend between the trailer motor 100, 101 and corresponding pair of wheels 30. Alternatively, a trailer motor 100, 101 may be mounted directly to, for directly driving, each trailer ground engager 30.

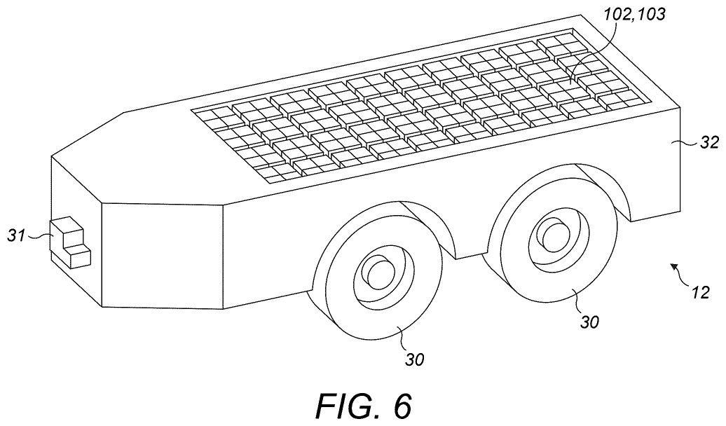

The trailer power source 102, 103 may be configured in any suitable manner for supplying electrical power to the trailer power system 19, may be an electrical power source, may comprise at least one battery and/or fuel cell and may comprise a plurality of electrochemical cells. As illustrated in FIG. 6, the trailer power source 102, 103 may be non-removable, mounted to and integrated with the trailer frame 32. In particular, the cells of the trailer power source 102, 103 may be non-removably mounted in place such that they are not swapped during use. In the present disclosure the term non-removable means that the trailer power source 102, 103 is not intended for removal during the lifetime of the trailer power source 102, 103 and is not generally removed for servicing or for charging. However, if the trailer power source 102, 103 ceases to operate effectively, the trailer power source 102, 103 may be replaced.

The trailer power system 19 may comprise a trailer charging port 105 connected to the trailer power distribution system 116 for releasably connecting to, to receive power from, an external power source 106 to recharge the trailer power source 102, 103 via the trailer power distribution system 116 without removing the trailer power source 102, 103 from the trailer unit 12.

The trailer power system 19 may comprise at least one auxiliary trailer motor 110 connected to the trailer power distribution system 116 for driving at least one auxiliary trailer system 111. The at least one auxiliary trailer system 111 may be the trailer fluid system 61. The trailer fluid system 61 may receive electrical power from the at least one auxiliary trailer motor 110 and transfer fluid power through the tractor-trailer services connection 67 to the tractor fluid system 60.

The trailer unit 12 may comprise the at least one haul body or tool 14, which may be operated by the trailer power system 19, such as either directly (such as by comprising an electrically powered actuator) or via the at least one auxiliary trailer motor 110. The trailer fluid system 61 may be for operating the at least one haul body or tool 14 and may comprise at least one trailer pump. The trailer power system 19 may be being configured to drive the at least one trailer pump to operate the at least one haul body or tool 14, for example by pumping pressurised fluid to a fluid cylinder to extend and retract to raise and lower a haul body 14. In other embodiments, the at least one haul body or tool 14 may be operated by the work machine fluid system 63.

The trailer power system 19 may comprise a trailer regeneration system 115 connected to the trailer power distribution system 116 for supplying power to the trailer power distribution system 116 for recharging the trailer power source 102, 103. The trailer regeneration system 115 may be connected to the trailer braking system 29 to recover power by regenerative braking.

The trailer power system 19 is connected to the trailer services connection 66 via the trailer power distribution system 116 for transferring power between the trailer services connection 66 and the at least one trailer motor 100, 101 and trailer power source 102, 103 and, if present, the trailer charging port 105, at least one auxiliary trailer motor 110 and/or trailer regeneration system 115.

Although not illustrated, the trailer power system 19 may also provide power to trailer electrical consumers, such as lights, the trailer control system 90 or the like, via the trailer power distribution system 116.

The tractor power system 18 comprises at least one tractor motor 120 driving the at least one tractor ground engager 21 and may comprise a tractor power source 121 for supplying power to the at least one tractor motor 120. The tractor power source 121 may be configured in any suitable manner for supplying electrical power to the tractor power system 18, may be an electrical power source, may comprise at least one battery and/or fuel cell and may comprise a plurality of electrochemical cells. The tractor power system 18 comprises a tractor power distribution system 126, for example comprising cables and/or buses, connecting the at least one tractor motor 120 and tractor power source 121.

As illustrated in FIG. 5, the or each tractor motor 120 may be mounted to a pair of tractor ground engagers 21, in this case wheels, such as by an axle. An axle powertrain may extend between the tractor motor 120 and pair of wheels 21. Alternatively, a tractor motor 120 may be mounted directly to, for directly driving, each tractor ground engager 21.

The tractor power system 18 may comprise at least one auxiliary tractor motor 122 connected to the tractor power distribution system 126 for driving at least one auxiliary tractor system 123. The at least one auxiliary tractor system 123 may be the tractor fluid system 60. The tractor fluid system 60 may receive electrical power from the at least one auxiliary tractor motor 122 and transfer fluid power through the tractor-trailer services connection 67 to the trailer fluid system 61. In other embodiments, the tractor fluid system 60 may be operated independently of the at least one auxiliary tractor motor 122.

The tractor power system 18 may comprise a tractor regeneration system 125 connected to the tractor power distribution system 126 for recharging the tractor power source 121. The tractor regeneration system 125 may be connected to the tractor braking system 28 to recover power by regenerative braking.

Although not illustrated, the tractor power system 18 may also provide power to trailer electrical consumers, such as lights, the tractor control system 80 or the like, via the tractor power distribution system 126.

Although not illustrated, the tractor power system 18 may comprise a tractor charging port connected to the tractor power distribution system 126 for releasably connecting to, to receive power from, the external power source 106 to supply power to the tractor power distribution system 126 to recharge the tractor power source 121 without removing the tractor power source 121 from the tractor unit 11.

The tractor power system 18 is connected to the tractor services connection 65 via the tractor power distribution system 126 for transferring power between the tractor services connection 65 and the at least one tractor motor 120 and, if present, the tractor power source 121, at least one auxiliary tractor motor 122 and/or tractor regeneration system 125.

The tractor and trailer power systems 18, 19 operate as a distributed power source between the tractor and trailer units 11, 12, by virtue of the tractor and trailer services connections 65, 66 allowing power transfer therethrough when coupled. When the tractor and trailer services connections 65, 66 are connected the tractor and trailer power distribution systems 126, 116 are connected to one another and power can be distributed between them. Hence together, via the tractor and trailer power distribution systems 126, 116, the tractor and trailer power systems 18, 19 operate as a fully integrated power distribution system amongst their various components.

Electrical power can be supplied to the tractor and trailer power distribution systems 126, 116 by the tractor and/or trailer power sources 102, 103, 121. Electrical power is thus distributed to the tractor motor 120 from the trailer power source 102, 103 and, if present, tractor power source 121, via the tractor and trailer power distribution systems 126, 116. Electrical power may be distributed to the trailer motors 100, 101 from the trailer power source 102, 103 and, if present, tractor power source 121, via the tractor and trailer power distribution systems 126, 116.

Only the at least one tractor motor 120 may be selectively driven by power distributed thereto by the tractor and/or trailer power distribution systems 126, 116 from the tractor and/or trailer power sources 102, 103, 121. Only the at least one trailer motor 100, 101 may be selectively driven by power distributed thereto by the tractor and/or trailer power distribution systems 126, 116 from the tractor and/or trailer power sources 102, 103, 121. Alternatively, the tractor and trailer motors 120, 100, 101 may be simultaneously driven by power distributed thereto by the tractor and/or trailer power distribution systems 126, 116 from the tractor and/or trailer power sources 102, 103, 121.

The auxiliary tractor and trailer motors 122, 110 may also be configured to be powered by electrical power from the tractor and/or trailer power sources 102, 103, 121 via the tractor and/or trailer power distribution systems 126, 116.

The power generated in the tractor and/or trailer regenerations systems 125, 115 may also be distributed to the tractor and/or trailer power distribution systems 126, 116, such as across the tractor-trailer services connection 67, for suppling power to and recharging the tractor and trailer power sources 102, 103, 121.

Power supplied from the external power source 106 to the tractor and/or trailer power system 18, 19 via the tractor and/or trailer charging port 105 may be distributed via the tractor and/or trailer power distribution systems 126, 116 to recharge the tractor and/or trailer power sources 102, 103, 121, such as via the tractor-trailer services connection 67.

The majority of, and/or at least 75% of and/or at least 85% of, the energy/power capacity of the tractor and trailer power sources 102, 103, 121 may be in the trailer unit 12.

### INDUSTRIAL APPLICABILITY

The trailer units 12 may be replaced when their power source charge reaches a predetermined low level, such as less than 10% charge. The method of operating the work machine system of the present disclosure may therefore comprise coupling and uncoupling different trailer units 12 from the tractor unit 11 to for different work machines 13 so as to efficiently use the power source storage of the work machine system 10.

The method comprises operating a first work machine 13 comprising the tractor unit 11 coupled to a first trailer unit 12. The at least one tractor motor 120 and, if present, at least one trailer motor 100, 101 of the first trailer unit 12 drive the tractor and trailer ground engagers 21, 30 by receiving electrical power from the trailer power source 102, 103 via the trailer power distribution system 116 of the first trailer unit 12 and the tractor power distribution system 126. The tractor and/or trailer motors 120, 100, 101 may also receive power from the tractor power source 121 and/or power regeneration systems 115, 125 via the trailer power distribution system 116 of the first trailer unit 12 and the tractor power distribution system 126. The first work machine 13 may be operated to perform a first work function.

Once the charge level of the trailer power source 102, 103 has reached a predetermined low level, the tractor unit is uncoupled from the first trailer unit, such as by uncoupling the tractor coupling 20 from the trailer coupling 31 of the first trailer unit 12. Alternatively, the tractor and/or trailer units 11, 12 may be connected to the tractor and/or trailer charging port 105 and the tractor and/or trailer power sources 121, 102, 103 may be recharged by receiving power from the external power source 106 via the tractor and/or trailer charging port 105 and trailer power distribution system 116 of the first trailer unit 12 and the tractor power distribution system 126.

The tractor unit 11 may be aligned with and/or coupled to a second trailer unit 12. The tractor unit 11 may be coupled to the second trailer unit 12 by coupling the tractor coupling 20 with the trailer coupling 31 of the second trailer unit 12, thereby forming a second work machine 13. Prior to such coupling, the trailer power source 102, 103 of the second trailer unit 12 may have been recharged by receiving power from the external power source 106 via the trailer charging port 105 and trailer power distribution system 116 of the second trailer unit.

The second work machine 13 may be operated, such as to perform a second work function different to the first work function. The at least one tractor motor 120 and, if present, at least one trailer motor 100, 101 of the second trailer unit 12 drive the tractor and trailer ground engagers 21, 30 by receiving electrical power from the trailer power source 102, 103 via the trailer power distribution system 116 of the second trailer unit 12 and the tractor power distribution system 126. The tractor and/or trailer motors 120, 100, 101 may also receive power from the tractor power source 121 and/or power regeneration systems 115, 125 via the trailer power distribution system 116 of the second trailer unit 12 and the tractor power distribution system 126.

The method may also comprise charging the tractor power source 121 of the tractor unit 11 and, when coupled to the tractor unit 11, the trailer power source 102, 103 of the first or second trailer unit 12 by receiving power from, an external power source 106 to a trailer charging port 105 of the first or second trailer unit 12. As a result, the tractor unit 11 may not require a dedicated charging port and instead can charge whilst the entire work machine 13 is not in use, such as during worksite downtime.

The method may also comprise charging the trailer power source 102, 103 of, when connected to the tractor unit 11, the first or second trailer unit 12 by power generated from a tractor and/or trailer regeneration system 125, 115. As a result, if the trailer power source 102, 103 is fully charged the tractor and/or trailer regeneration system 125, 115 can recharge the tractor power source 121 or if the tractor power source 121 is fully charged the tractor and/or trailer regeneration system 125, 115 can recharge the trailer power source 102, 103.

1. A interchangeable trailer unit for releasably coupling to a tractor unit to form a work machine, the tractor unit comprising a tractor power system, the tractor power system comprising a tractor power distribution system connected to at least one tractor motor, the at least one tractor motor being for driving tractor ground engagers about a tractor rotational axis, wherein the tractor unit comprises no further driven tractor ground engagers and when driven is balanced by the trailer unit, wherein the trailer unit comprises:
at least one trailer ground engager;
a trailer power system comprising a trailer power distribution system connected to a trailer power source; and
a trailer services connection for releasably connecting to a tractor services connection of the tractor unit for connecting the trailer power distribution system to the tractor power distribution system such that electrical power can be distributed therebetween such that electrical power from the trailer power source is suppliable to the at least one tractor motor.

2. The trailer unit as claimed in claim 1 further comprising a trailer frame, wherein the trailer power system comprises at least one trailer motor for driving the at least one trailer ground engager and the at least one trailer motor is connected to the trailer power distribution system such that power from the trailer power source is suppliable to the at least one tractor motor.

3. The trailer unit as claimed in claim 1 wherein:
the trailer power source is mounted to and integrated with the trailer frame;
the trailer power system comprises a charging port for receiving power from an external power source to recharge the trailer power source without removing the trailer power source; and/or
the trailer power source comprises at least one trailer battery and/or fuel cell.

4. The trailer unit as claimed in claim 2 wherein the tractor power system further comprises a tractor power source connected to the tractor power distribution system and the trailer services connection is for releasably electrically connecting the trailer power distribution system to the tractor power distribution system such that the tractor and/or trailer motors are driveable by electrical power from the tractor and/or trailer powers sources.

5. The trailer unit as claimed in claim 2 wherein, the trailer power system comprises a trailer power regeneration system connected to, for suppling power to, the trailer power distribution system.

6. The trailer unit as claimed in claim 2 wherein, the trailer unit further comprises at least one haul body or tool operated by the trailer power system.

7. The trailer unit as claimed in claim 6 wherein, the trailer unit further comprises a trailer fluid system for operating the at least one haul body or tool and comprising at least one trailer pump, the trailer power system being configured to drive the at least one trailer pump to operate the at least one haul body or tool.

8. The trailer unit as claimed in claim 2 further comprising a trailer coupling for releasably coupling to a tractor coupling of the tractor unit for mechanically connecting the tractor and trailer units together.

9. A work machine system comprising:
a tractor unit comprising a tractor power system having a tractor power distribution system connected to at least one tractor motor for driving tractor ground engagers about a tractor rotational axis, wherein the tractor unit comprises no further driven tractor ground engagers; and
a plurality of trailer units, each trailer unit comprising at least one trailer ground engager and a trailer power system having a trailer power distribution system connected to a trailer power source, wherein each trailer unit is releasably coupleable to the tractor unit for balancing the tractor unit,
wherein, the tractor unit comprises a tractor services connection and each trailer unit comprises a trailer services connection, wherein the tractor and trailer services connections are for releasably electrically connecting the tractor power distribution system to the trailer power distribution system of each trailer unit such that electrical power can be distributed to the tractor motor from the trailer power source.

10. The work machine system as claimed in claim 9 wherein, the tractor power system comprises a tractor power source connected to the tractor services connection and the tractor and trailer services connections are for releasably electrically connecting the tractor and trailer power distribution systems such that electrical power can be distributed to the at least one tractor motor from the tractor and trailer power sources.

11. The work machine system as claimed claim 10 wherein:
the trailer power system comprises a trailer power regeneration system connected to, for supplying power to, the trailer power distribution system for recharging the trailer power source and/or tractor power source; and/or
the tractor power system comprises a tractor power regeneration system connected to, for supplying power to, the tractor power distribution system for recharging the trailer power source and/or tractor power source.

12. The work machine system as claimed in claim 9 wherein the trailer power system comprises a trailer charging port for releasably connecting to, to receive power from, an external power source and the trailer power system is configured to distribute power from the trailer charging port to the tractor power system via the trailer and tractor power distribution systems.

13. The work machine system as claimed in claim 9 wherein:
the tractor and/or trailer units comprise a steering system for steering the work machine by pivoting the tractor unit relative to the trailer unit about an articulation joint;
different work machines with different work functions are formed when different trailer units are coupled to the tractor unit;
the tractor unit is not independently moveable about the ground by the tractor power system when the tractor unit is not coupled to a trailer unit; and/or
the centre of mass of the tractor unit is offset from the at least one tractor ground engager such that the tractor unit is unbalanced when not coupled to a trailer unit.

14. The method of operating the work machine system of claim 9, wherein, the method comprises:
operating a first work machine comprising the tractor unit coupled to a first trailer unit, wherein the at least one tractor motor drives the at least one tractor ground engager by receiving electrical power from the trailer power source via the trailer power distribution system of the first trailer unit and/or the tractor power distribution system;
uncoupling the tractor unit from the first trailer unit;
coupling the tractor unit to a second trailer unit, thereby forming a second work machine; and
operating a second work machine, wherein the at least one tractor motor drives the at least one tractor ground engager by receiving electrical power from the trailer power source via the trailer power distribution system of the second trailer unit and/or the tractor power distribution system.

15. The method as claimed in claim 14 comprising:
charging, via the trailer power distribution system, the trailer power source of the first or second trailer unit by receiving power from, an external power source to a trailer charging port of the first or second trailer unit; and/or
charging, via the trailer power distribution system, the trailer power source of, when connected to the tractor unit, the first or second trailer unit by power generated from a tractor and/or trailer power regeneration system.
